(19) United States
(12) Patent Application Publication
(10) Pub. No.: US 2026/0233484 A1
(43) Pub. Date: Aug. 13, 2026

(54) METHOD FOR PRODUCING A HYBRID COMPONENT, AND PRESSING TOOL FOR PRODUCING A HYBRID COMPONENT

(71) Applicant: KAUTEX TEXTRON GMBH & CO. KG, Bonn (DE)

(72) Inventor: Daniel HEIDRICH, Rommerskirchen (DE)

(21) Appl. No.: 19/156,769

(22) PCT Filed: Feb. 21, 2024
(86) PCT No.: PCT/EP2024/054374

§ 371 Date: Aug. 14, 2025

(30) Foreign Application Priority Data
Feb. 27, 2023 (DE) 10 2023 104 738.8

(51) Int. Cl. B30B 9/28; H01M 50/224; H01M 50/227; H01M 50/231; H01M 50/249

(52) U.S. Cl. CPC B30B 9/28; H01M 50/224; H01M 50/227; H01M 50/231; H01M 50/249; H01M 2220/20

(57) ABSTRACT

A method for producing a hybrid component which includes at least one plastics layer and at least one protection element connected to the plastics layer, the method includes providing a pressing tool comprising a lower tool part and an upper tool part that are movable relative to one another between an open position and a closed position; placing at least one protection element and at least one polymer melt into the pressing tool so that the polymer melt and the protection element are arranged above one another; and closing the pressing tool, such that the upper tool part comes into contact with the at least one polymer melt or the at least one protection element reshaping the polymer melt by way of applying pressure via the pressing tool, and connecting the at least one polymer melt to the at least one protection element by forming the plastics layer.

The present invention relates to a method for producing a hybrid component for traction battery housings or for a motor vehicle underbody protection by means of a pressing tool. The present invention further relates to a pressing tool for producing a hybrid component.

Hybrid components are components that comprise at least two components or material components. For example, a hybrid component is a component having a plastics layer and a metal layer. It is known from the prior art to form a plastic component by means of, for example, an extrusion process, which, after its production, is connected to a metal component for reinforcing the component, so that the finished component comprises a plastics layer and a metal layer.

A corresponding production method involves a large number of work steps carried out one after the other and is therefore complex in terms of spatial and temporal coordination.

In particular, the production of large-area hybrid components, such as components for a battery housing of a traction battery for electric vehicles (e.g., a battery housing lower shell, a battery housing upper shell or a battery housing cover) or an underbody protection for motor vehicles, is time-consuming and costly.

The present invention is based on the object of providing a method for producing a hybrid component by means of a pressing tool, by means of which stable and large-area hybrid components can be produced with reduced time expenditure and at low cost.

The object underlying the present invention is achieved by a method for producing a hybrid component having at least one plastics layer and having at least one protection element connected thereto according to claim 1. Advantageous embodiments of the method are described in the claims dependent on claim 1.

More specifically, the object underlying the present invention is achieved by a method for producing a hybrid component that comprises at least one plastics layer and at least one protection element connected to the plastics layer, wherein the method comprises the following method steps:
Providing a pressing tool which comprises a lower tool part and an upper tool part, wherein the upper tool part and the lower tool part are movable relative to one another along a movement direction or movement axis between an open position and a closed position of the pressing tool;
Placing at least one protection element and at least one polymer melt into the pressing tool in the open position, in such a way that the polymer melt and the protection element are arranged one above the other along the movement direction; and
Closing the pressing tool, with the result that the upper tool part comes into contact at least indirectly with the at least one polymer melt or with the at least one protection element and the polymer melt is reshaped by way of application of pressure by means of the upper tool part and/or by means of the lower tool part and the at least one polymer melt is connected to the at least one protection element with the formation of the plastics layer.

The method according to the invention has the advantage that a hybrid component with increased stability can be produced off tool. Due to the off-tool production, the production costs of the hybrid part are significantly reduced and at the same time the production time is significantly reduced.

The hybrid component is preferably designed as a hybrid component for a battery housing of a traction battery. For example, the hybrid component is designed as a battery housing and/or battery housing lower shell and/or battery housing upper shell and/or battery housing cover and/or as underbody protection.

The hybrid component is preferably designed as a hybrid component for underbody protection of a motor vehicle.

The lower tool part is preferably designed as a die. The upper tool part is preferably designed as a punch.

In the closed position of the pressing tool, the lower tool part and the upper tool part are spaced less apart than in the open position of the pressing tool.

The feature according to which the upper tool part comes into contact with the polymer melt at least indirectly when the pressing tool is closed means that the upper tool part comes into contact with the polymer melt either directly or by means of a further component (for example, via a protection element).

Preferably, two or more protection elements are placed in the pressing tool in the open position. Further preferably, the at least two protection elements are arranged next to one another with respect to the movement direction of the upper tool part to the lower tool part. Further preferably, the at least two protection elements are connected to one another by the plastics layer of the hybrid component. A method designed in this way allows a hybrid component with increased thermal and mechanical resistance to be produced off tool, even with complex geometric shapes of the hybrid component, and thus at a significantly lower cost and significantly faster.

Preferably, two or more polymer melts are placed in the pressing tool in the open position. Further preferably, the at least two polymer melts are arranged next to one another with respect to the movement direction of the upper tool part to the lower tool part. A method designed in this way allows a particularly large hybrid component to be produced in a tool-releasing manner.

The pressing tool can be designed as a plunge-edge tool. With a plunge-edge tool, the punch penetrates into the die in the closed position of the plunge-edge tool in such a way that a substantially sealed space is created, wherein a gap of between 0.05 mm and 0.2 mm remains between the punch and the die.

The polymer melt preferably comprises a matrix material and/or a fiber material. The matrix material can comprise or be formed from a polypropylene (PP) and/or a polyamide (PA) and/or another polymer. The fiber material can comprise or be formed from glass fibers and/or carbon fibers and/or aramid fibers.

The polymer melt can be formed as a sheet molding compound (SMC) with glass fiber reinforcement or as a glass mat thermoplastic (GMT) comprising a glass fiber reinforced PP or as a direct long fiber thermoplastic (D-LFT) comprising a glass fiber reinforced PP and/or PA.

The at least one protection element preferably comprises a steel sheet and/or an aluminum sheet and/or an organic sheet. Further preferably, the at least one protection element is designed as a steel sheet or as an aluminum sheet or as an organic sheet. The protection element preferably comprises a thickness in the range between 0.8 mm and 4 mm.

Organic sheets are fiber-matrix semi-finished products. These consist of a fiber fabric or a fiber nonwoven embedded in a thermoplastic plastic matrix. As a result, hot reshaping capability can be improved and thus fabrication times can be shortened. In addition, the flexural rigidity of the hybrid component can be improved.

Preferably, the polymer melt is connected to the at least one protection element in a form-fitting and/or material-fitting manner.

Further preferably, the method is designed in such a way that the at least one protection element is deformed by exerting force by means of the at least one polymer melt.

By means of the correspondingly designed method, a hybrid component with even better stability is produced, since the rigidity of the protection element and thus also the rigidity of the hybrid component is increased due to the shaping of the protection element. The hybrid component can still be produced in a tool-releasing manner, since the reshaping of the protection element is carried out during the bonding process of the polymer melt with the protection element.

Preferably, the lower tool part and/or the upper tool part comprises a shaping to which the protection element adapts during its deformation.

The actual exertion of force is carried out via the closing movement of the pressing tool. Due to the contact of the polymer melt with the protection element, the force required for deforming the protection element is exerted or transmitted by means of the polymer melt.

Preferably, the lower tool part and/or the upper tool part comprises a shaping that is designed in such a way that the at least one protection element forms a flange if the at least one protection element adapts to the shaping of the lower tool part and/or the upper tool part. In other words, due to the shaping of the lower tool part and/or the upper tool part, deep drawing of the protection element can be achieved at the same time, so that a flange is formed. As a result, a hybrid component with increased stability can be produced off tool.

The flange can be designed as a circumferential wing flange. Due to a circumferential wing flange, a hybrid component can be better connected to a further component, e.g. a battery housing. At the same time, the stability of the hybrid component increases.

The flange can exhibit a width extension in the range between 8 mm and 25 mm, preferably in the range between 10 mm and 15 mm.

Preferably, the lower tool part and/or the upper tool part comprises a shaping that is designed in such a way that recesses and/or elevations are formed in the hybrid component and/or in the at least one protection element if the at least one protection element is deformed by exerting force by means of the at least one polymer melt. As a result, an even more complex hybrid component can be produced off tool. This is because the additional elevations and/or recesses can be created during the bonding process of the polymer melt with the protection element.

The recesses and/or elevations can be designed in such a way that, for example, screw heads can be countersunk into the recesses and/or elevations. As a result, the hybrid component can be better connected to a further component, such as a battery housing cover, by means of screws.

If the method is designed in such a way that a first and a second protection element are introduced into the pressing tool and are connected by means of the pressing tool to the polymer melt arranged between them, the method can be designed in such a way that the first protection element and the second protection element are deformed. Consequently, the method then comprises the following method step: deforming the first protection element and/or the second protection element by exerting force by means of the at least one polymer melt. As a result, a hybrid component with even better stability can be produced off tool.

Further preferably, the method is designed in such a way that the at least one protection element is placed in the pressing tool in the open position, in such a way that the at least one protection element rests at least indirectly on the lower tool part and that the at least one polymer melt is placed on the at least one protection element.

By means of the correspondingly designed method, the at least one protection element can be placed in the lower tool part with increased positioning accuracy and thus the fabrication accuracy of the hybrid component can be significantly improved.

Preferably, the at least one protection element is placed on an ejection device of the pressing tool. The ejection device can be realized, for example, in the form of ejection pins located in the lower tool part, which are arranged in the lower tool part. After finishing of the hybrid component, the ejector pins can be moved out of respective recesses in the lower tool part, as a result of which the finished hybrid component is ejected from the pressing tool.

The ejector pins can be designed as hydraulically controlled ejector pins. As a result, the required demolding force can be individually adapted to the respective hybrid component, so that a uniform mechanical load acts on the hybrid component during demolding.

The protection element can also be designated as the first protection element.

Further preferably, the method is designed in such a way that a second protection element is placed in the pressing tool in the open position in such a way that the polymer melt is arranged between a first protection element, which rests at least indirectly on the lower tool part, and the second protection element. Furthermore, the pressing tool is closed, so that the upper tool part comes into contact at least indirectly with the second protection element and the polymer melt is connected to the first protection element and the second protection element by way of application of pressure by means of the upper tool part and/or by means of the lower tool part.

The correspondingly designed method makes possible the production of an even more stable hybrid component. This is because the correspondingly produced hybrid component comprises three layers, wherein the plastics layer is sandwiched between the first protection element and the second protection element and connected to them.

The method also makes possible the off-tool production of this more complex hybrid component. As a result, even for this more complex hybrid component, the production time can be significantly reduced and the production costs can be significantly lowered.

The second protection element can be inserted into the pressing tool in the open position in such a way that the second protection element is arranged directly or indirectly on the upper tool part. Preferably, the second protection element can be arranged on the upper tool part by magnetic force and/or by being suctioned in place via a vacuum. As a result, the pressing tool can be closed immediately after the polymer melt has been placed, so that the production time of a hybrid component can be significantly reduced.

Further preferably, the method is designed in such a way that a pressing tool is provided which comprises a lower tool part and an upper tool part, wherein the upper tool part and the lower tool part are movable relative to one another along a movement direction between an open position and a closed position of the pressing tool, and wherein a plurality of recesses are formed in the lower tool part and/or in the upper tool part and a plurality of ribs are formed from material of the polymer melt during the closing of the pressing tool by pressing the material of the polymer melt into the recess.

The correspondingly designed method makes possible the off-tool production of a hybrid component with monolithically formed ribs. The method for this more complex hybrid component therefore has the advantage that the hybrid component can be fabricated at lower production costs and with a reduced production time.

The ribs can be monolithically connected to the plastics layer.

Two monolithically connected components are fabricated from a single continuous piece. In particular, two monolithically connected parts are connected seamlessly.

Further preferably, the method is designed in such a way that at least one protection element having a plurality of through-openings and the at least one polymer melt are placed in the pressing tool in the open position in such a way that the polymer melt and the protection element are arranged one above the other along the movement direction, and that the respective through-openings are in each case oriented in alignment with the respective recesses, so that the respective recesses are accessible via the respective through-openings. A plurality of ribs are formed from the polymer melt during the closing of the pressing tool by pressing the polymer melt through the respective through-openings into the respective recesses.

The correspondingly designed method makes possible the off-tool production of an even more stable hybrid component with monolithically formed ribs. This is because the correspondingly produced hybrid component comprises three layers, wherein the plastics layer is sandwiched between the first protection element and the second protection element and is connected to them, and the ribs, which are monolithically connected to the plastics layer, protrude through the through-openings of a protection element. As a result, even for this once again more complex hybrid component, the production time can be significantly reduced and the production costs can be significantly lowered.

Further preferably, the method is designed in such a way that the at least one protection element is heated before being brought into contact with the at least one polymer melt and/or before the pressing tool is closed.

The correspondingly designed method has the advantage that the polymer melt can flow more easily on the protection element. As a result, a more uniform and thus improved connection between the protection element and the polymer melt, in particular between a protection element designed as a steel sheet and/or an aluminum sheet and the polymer melt, can be carried out.

The protection element can be heated, for example, by means of a convection oven, infrared radiation, induction or a heating plate.

Further preferably, the method is designed in such a way that a contact surface of the at least one protection element, which is connected to the at least one polymer melt with the formation of the plastics layer, is microstructured.

As a result, a micro-form fit between the at least one protection element and the polymer melt can be achieved when the pressing tool is being closed.

A micro-form fit within the meaning of the invention is understood to mean a form fit between two components, wherein one component is at least partially engaged by the other component at a plurality of locations. As a result, an improved form fit with increased connection force can be achieved. In addition, as a result, two components made of different materials, such as plastic and metal, can be connected together more effectively.

The microsurface structure of the contact surface of the at least one protection element is created, for example, by means of a laser microstructuring method and/or by means of sandblasting or corundum blasting and/or by means of an etching method.

Further preferably, the method is designed in such a way that an adhesion promoter is applied to a contact surface of the at least one protection element, which is connected to the at least one polymer melt with the formation of the plastics layer.

The adhesion promoter layer can achieve an improved connection, in particular an improved material-fitting connection between the contact surface of the at least one protection element and the plastics layer.

The adhesion promoter layer can be formed as a heat-activatable adhesive layer, preferably in the form of a film, a lacquer and/or a powder coating. The powder coating can be formed on a thermoplastic or thermosetting plastic basis. As a result, a further improved material-fitting connection between the polymer melt and the at least one protection element can be achieved.

A further object underlying the present invention is to provide a pressing tool for producing a hybrid component, wherein the pressing tool makes possible a more cost-effective and faster production of a hybrid component with increased stability.

This object underlying the present invention is achieved by a pressing tool for producing a hybrid component having the features of claim 10. Advantageous embodiments are described in the claims dependent on claim 10.

More specifically, the object underlying the present invention is achieved by a pressing tool for producing a hybrid component that comprises at least one plastics layer and at least one protection element connected to the plastics layer. The pressing tool comprises a lower tool part and an upper tool part, wherein the upper tool part and the lower tool part are movable relative to one another along a movement direction between an open position and a closed position of the pressing tool. The pressing tool also comprises a holding device for holding the at least one protection element in the pressing tool. The pressing tool is designed so that when the pressing tool is transferred into its closed position, a polymer melt introduced into the pressing tool and a protection element introduced into the pressing tool are pressed onto one another and connected to one another, wherein the polymer melt introduced into the pressing tool is deformed with the formation of the plastics layer.

The pressing tool according to the invention has the advantage that a hybrid component with increased stability can be produced off tool. Due to the off-tool production, the production costs of the hybrid part are significantly reduced and at the same time the production time is significantly reduced.

The lower tool part is preferably designed as a die. The upper tool part is preferably designed as a punch.

The pressing tool can be designed as a plunge-edge tool. With a plunge-edge tool, the punch penetrates into the die in the closed position of the plunge-edge tool in such a way that a substantially sealed space is created, wherein a gap of between 0.05 mm and 0.2 mm remains between the punch and the die.

Preferably, the pressing tool is designed in such a way that a plurality of recesses are formed in the lower tool part and/or in the upper tool part. The pressing tool is preferably designed so that when the pressing tool is transferred into its closed position, the polymer melt is pressed at least partially into the plurality of recesses, so that the plastics layer comprises a plurality of ribs monolithically connected to it.

The pressing tool designed in this way has the advantage that a more complex hybrid component with increased stability can be produced off tool. Due to the off-tool production, the production costs of the more complex hybrid part are significantly reduced and at the same time the production time is significantly reduced, even though the hybrid component is more complex to produce.

Preferably, the pressing tool is designed in such a way that the pressing tool comprises an ejection device for ejecting the hybrid component. The ejection device is preferably designed to separate the hybrid component from the lower tool part and/or the upper tool part after finishing of the hybrid component by way of application of force to the hybrid component.

The pressing tool designed in this way has the advantage that the hybrid component can be produced as an off-tool component regardless of the geometric design. As a result, even with complex geometries of the hybrid component, the hybrid component can be produced with reduced production costs and reduced production time.

The ejection device can preferably be realized in the form of ejection pins located in the lower tool part and/or in the upper tool part, which are arranged in the lower tool part and/or in the upper tool part. After finishing of the hybrid component, the ejector pins can be moved out of respective recesses in the lower tool part and/or in the upper tool part, as a result of which the finished hybrid component is ejected from the pressing tool.

The ejector pins can be designed as hydraulically controlled ejector pins. As a result, the required demolding force can be individually adapted to the respective hybrid component, so that a uniform mechanical load acts on the hybrid component during demolding.

Preferably, the pressing tool is designed in such a way that the upper tool part and/or the lower tool part comprises a reshaping device for reshaping the at least one protection element. The pressing tool is preferably designed to deform the at least one protection element by way of application of force by means of the at least one polymer melt in the direction of the reshaping device during the closing movement of the pressing tool.

The pressing tool designed in this way has the advantage that a hybrid component can be produced with even better stability, since the rigidity of the protection element and thus also the rigidity of the hybrid component is increased due to the shaping of the protection element. The hybrid component can still be produced in a tool-releasing manner, since the reshaping of the protection element is carried out during the bonding process of the polymer melt with the protection element.

Preferably, the reshaping device of the pressing tool is designed in such a way that the protection element adapts to the shaping of the reshaping device if the protection element is deformed.

Preferably, the reshaping device of the pressing tool is designed in such a way that the at least one protection element forms a flange if the at least one protection element adapts to the shaping of the reshaping device of the pressing tool. In other words, due to the shaping of the reshaping device of the pressing tool, deep drawing of the protection element can be achieved at the same time, so that a flange is formed. As a result, a hybrid component with increased stability can be produced in one fabrication step.

The flange can be designed as a circumferential wing flange. A circumferential wing flange enables a hybrid component to be better connected to a further component, e.g. a battery housing cover. At the same time, the stability of the hybrid component increases again.

Preferably, the lower tool part and/or the upper tool part comprises a shaping that is designed in such a way that recesses and/or elevations are formed in the hybrid component and/or in the at least one protection element if the at least one protection element is deformed by exerting force by means of the at least one polymer melt. As a result, an even more complex hybrid component can be produced in a tool-releasing manner. This is because the additional elevations and/or recesses can be created during the bonding process of the polymer melt with the protection element.

The recesses and/or elevations can be designed in such a way that, for example, screw heads can be countersunk into the recesses and/or elevations. As a result, the hybrid component can be better connected to a further component, such as a battery housing cover, by means of screws.

Preferably, the pressing tool is designed in such a way that the pressing tool comprises a hold-down device attached to the lower tool part, which can be moved in the movement direction between a first position and a second position. In the first position, the at least one protection element can be clamped between the hold-down device and the upper tool part and in the second position, the at least one protection element is arranged loosely between the hold-down device and the upper tool part with respect to the movement direction. The pressing tool is designed to hold the at least one protection element clamped between the hold-down device in the first position and the upper tool part during the closing movement. Furthermore, the pressing tool is designed to deform the at least one protection element by way of application of force by means of the at least one polymer melt during the closing movement of the pressing tool.

The pressing tool designed in this way has the advantage that a hybrid component can be produced with even better stability and increased quality. Due to the hold-down device, a uniform flow process of the protection element can be achieved during the deformation of the at least one protection element and, in particular, the formation of folds in the vicinity of the flow zone of the at least one protection element can be avoided. As a result, high degrees of reshaping can be achieved while maintaining the same quality of the hybrid component.

The feature that the at least one protection element is arranged loosely between the hold-down device and the upper tool part with respect to the movement direction in the second position of the hold-down device can also be expressed in such a way that the at least one protection element is not clamped between the hold-down device and the upper tool part in the second position of the hold-down device.

The first position of the hold-down device is preferably reached during the closing movement of the pressing tool before the closing position of the pressing tool. As a result, the at least one protection element is clamped between the hold-down device and the upper tool part before the at least one protection element is deformed.

The second position of the hold-down device is preferably reached during the opening movement of the pressing tool before the open position of the pressing tool. As a result, the hybrid component can be ejected more quickly after finishing.

The hold-down device can comprise a spring bearing. As a result, the clamping force can be adjusted more effectively during the deformation of at least one protection element.

The spring bearing can be designed to be hydraulic, mechanical or pneumatic.

Preferably, the pressing tool is designed in such a way that the upper tool part comprises a holding device for holding the at least one protection element in the pressing tool. The holding device is preferably designed as a magnetic holding device or as a holding device generating a negative pressure.

The pressing tool designed in this way has the advantage that the pressing tool can be closed immediately after the polymer melt has been placed. As a result, the production time of a hybrid component can be significantly reduced.

The magnetic holding device can be designed as a magnetic ejector pin. In other words, an ejector pin can also be a magnetic holding device. Due to this functional integration, a pressing tool can be produced at a lower cost, as a result of which, in turn, a hybrid component can be produced at a lower cost.

The holding device generating a negative pressure can be designed as an ejector pin generating a negative pressure. In other words, an ejector pin can at the same time be a holding device generating a negative pressure. Due to this functional integration, a pressing tool can be produced at a lower cost, as a result of which, in turn, a hybrid component can be produced at a lower cost.

Further advantages, details, and features of the invention can be found below in the described exemplary embodiments. In the figures, in detail:

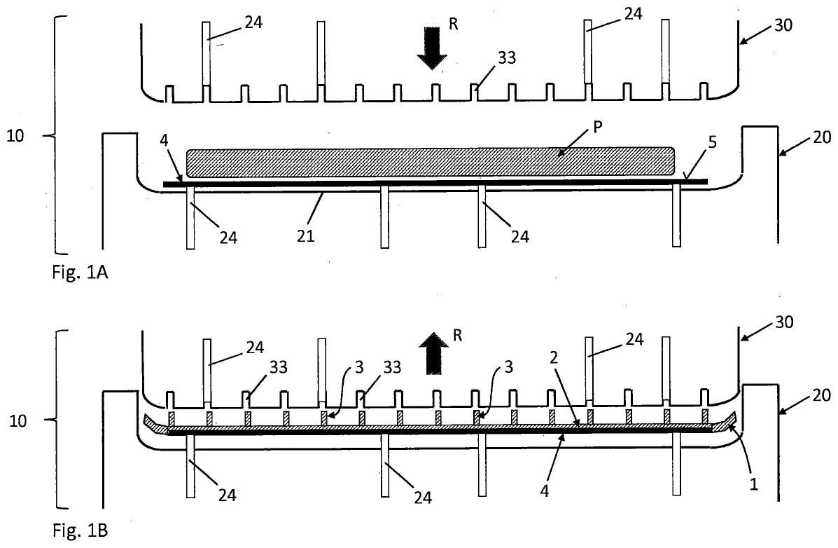

FIG. 1A: is a schematic sectional view of a pressing tool according to the invention according to a first embodiment in an open position;

FIG. 1B: is a schematic sectional view of the pressing tool shown in FIG. 1A after finishing of a hybrid component in an opening movement after leaving a closed position of the pressing tool;

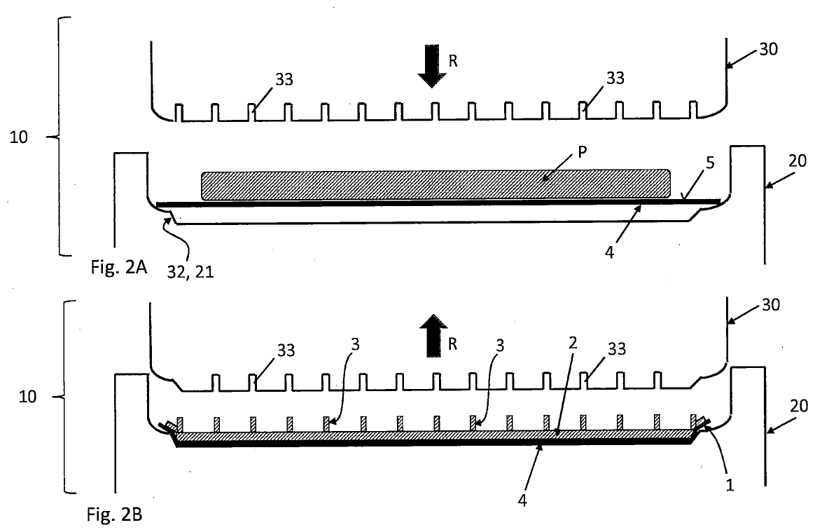

FIG. 2A: is a schematic sectional view of a pressing tool according to the invention according to a second embodiment in an open position;

FIG. 2B: is a schematic sectional view of the pressing tool shown in FIG. 2A after finishing of a hybrid component in an opening movement after leaving a closed position of the pressing tool;

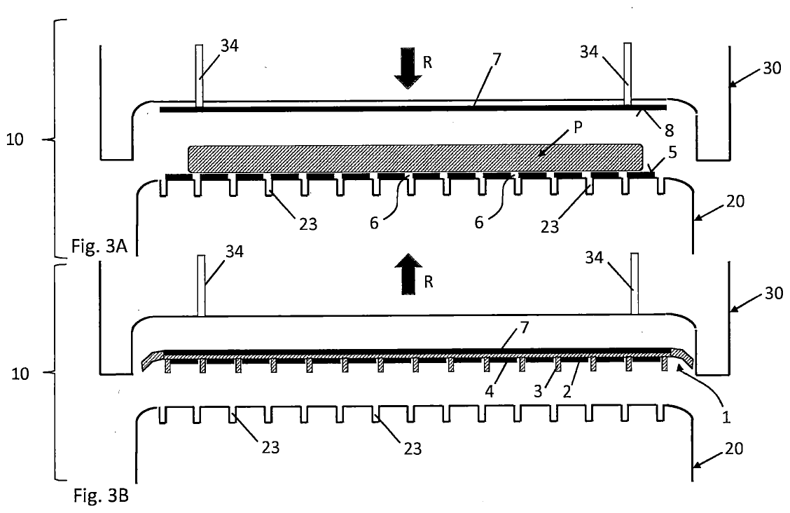

FIG. 3A: is a schematic sectional view of a pressing tool according to the invention according to a third embodiment in an open position;

FIG. 3B: is a schematic sectional view of the pressing tool shown in FIG. 3A after finishing of a hybrid component in an opening movement after leaving a closed position of the pressing tool;

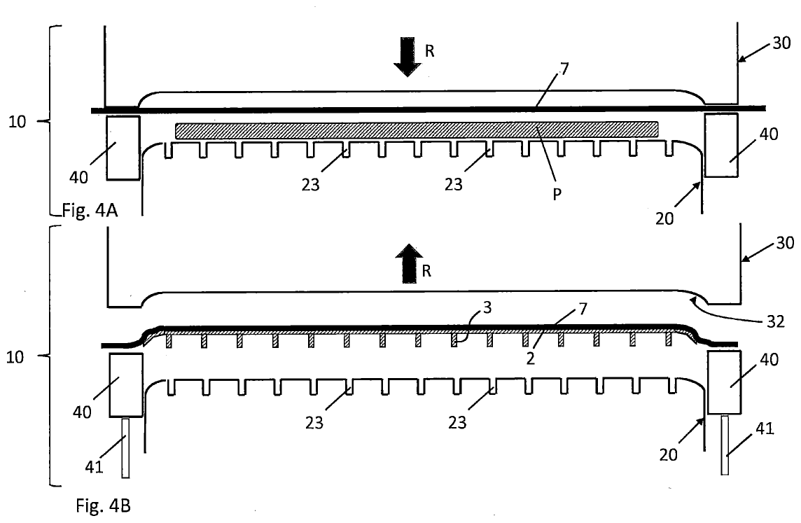

FIG. 4A: is a schematic sectional view of a pressing tool according to the invention according to a fourth embodiment in a first position of a hold-down device; and

FIG. 4B: is a schematic sectional view of the pressing tool shown in FIG. 4A, wherein the hold-down device is located in a second position.

In the following description, the same reference signs denote the same components or features; in the interest of avoiding repetition, a description of a component made with reference to one drawing also applies to the other drawings. Furthermore, individual features that have been described in connection with one embodiment can also be used separately in other embodiments.

A method for producing a hybrid component 1 is explained using the pressing tool 10 shown in FIGS. 1A and 1B. FIG. 1A shows a schematic sectional view of a pressing tool 10 for producing a hybrid component 1 in an open position according to a first embodiment of the present invention. The pressing tool 10 comprises a lower tool part 20 and an upper tool part 30, wherein the lower tool part 20 and the upper tool part 30 are movable relative to one another along a movement direction R between an open position and a closed position of the pressing tool 10. The pressing tool 10 also comprises a holding device 21 for holding the at least one protection element 4 in the pressing tool 10.

In an open position of the pressing tool 10 shown in FIG. 1A, at least one protection element 4 and at least one polymer melt P are placed in the pressing tool 10 in such a way that the polymer melt P and the protection element 4 are arranged one above the other along the movement direction R.

The protection element 4 is placed in the pressing tool 10 in the open position in such a way that the protection element 4 rests at least indirectly on the lower tool part 20. The polymer melt P is placed on the protection element 4.

The pressing tool 10 is designed so that when the pressing tool 10 is transferred into its closed position, the polymer melt P introduced into the pressing tool 10 and the protection element 4 introduced into the pressing tool 10 are pressed onto one another and connected to one another, wherein the polymer melt P introduced into the pressing tool 10 is deformed with the formation of a plastics layer 2 of the hybrid component 1 shown in FIG. 1B.

The hybrid component 1 produced in this way thus comprises at least one plastics layer 2 and at least one protection element 4 connected to the plastics layer 2.

FIG. 1B shows a schematic sectional view of a pressing tool 10 for producing a hybrid component 1 in an opening movement after finishing of the hybrid component 1 after leaving a closed position according to the first embodiment of the present invention.

A plurality of recesses 33 are formed in the upper tool part 30. The pressing tool 10 is designed in such a way that, when the pressing tool 10 is transferred into its closed position, the polymer melt P is pressed at least partially into the plurality of recesses 33, so that the plastics layer 2 comprises a plurality of ribs 3 monolithically connected to it.

The hybrid component 1 produced in this way consequently comprises at least one plastics layer 2 and at least one protection element 4 connected to the plastics layer 2, wherein the plastics layer 2 comprises a plurality of ribs 3 monolithically connected to the plastics layer 2.

The pressing tool 10 comprises an ejection device 24 for ejecting the hybrid component 1, wherein the ejection device 24 is designed to separate the hybrid component 1 from the lower tool part 20 and/or the upper tool part 30 by way of application of force to the hybrid component 1 after finishing of the hybrid component 1.

The ejection device 24 is realized in the form of ejector pins 24 located in the lower tool part and in the upper tool part.

The ejector pins 24, which are arranged in the upper tool part 30, are arranged in alignment with a plurality of recesses 33, so that after finishing of the hybrid component 1, the hybrid component 1 can be separated from the upper tool part 30 by way of application of force to a plurality of ribs 3 of the hybrid component 1.

FIGS. 2A and 2B show a pressing tool 10 according to a second embodiment of the present invention, wherein in FIG. 2A the pressing tool 10 is shown in an open position and in FIG. 2B in an opening movement after leaving a closed position. The production process of a further hybrid component 1 is explained using the pressing tool 10 shown in FIGS. 2A and 2B.

The lower tool part 20 of the pressing tool 10 shown in FIG. 2A comprises a reshaping device 32 for reshaping the protection element 4. The pressing tool 10 is designed to deform the protection element 4 by way of application of force by means of the polymer melt P in the direction of the reshaping device 32 during the closing movement of the pressing tool 10.

The hybrid component 1 produced by a pressing tool 10 according to the second embodiment comprises a protective layer 4, which has conformed to the shaping of the reshaping device 32 of the lower tool part 20.

In FIGS. 2A and 2B, it is not shown that the pressing tool 10 comprises an ejection device. However, the pressing tool 10 according to the second embodiment can also comprise an ejection device 24. With regard to the configuration of the ejection device 24, reference is made to the above description with reference to FIGS. 1A and 1B.

The remaining structure of the pressing tool 10 according to the second embodiment corresponds to the structure of the pressing tool 10 according to the first embodiment, so that in order to avoid repetition, reference is made to the above explanations.

FIGS. 3A and 3B show a schematic cross-sectional view of a pressing tool 10 according to a third embodiment. The production process of a hybrid component 1 is explained using the pressing tool 10 shown in FIGS. 3A and 3B.

The upper tool part 30 of the pressing tool 10 comprises a holding device 34 for holding a second protection element 7 in the pressing tool 10. The holding device 34 can be designed as a magnetic holding device 34 or as a holding device 34 generating a negative pressure.

In an open position of the pressing tool 10, the second protection element 7 is placed in the pressing tool 10 in such a way that the polymer melt P is arranged between the first protection element 4, which rests on the lower tool part 20, and the second protection element 7.

Subsequently, the pressing tool 10 is closed so that the polymer melt P is connected to the first protection element 4 and the second protection element 7 by way of application of pressure by means of the upper tool part 30 and/or by means of the lower tool part 20.

The first protection element 4 comprises a plurality of through-openings 6. The polymer melt P and the first protection element 4 are placed in the pressing tool 10 in the open position in such a way that the polymer melt P and the protection element 4 are arranged one above the other along the movement direction R, and that the respective through-openings 6 are in each case oriented in alignment with the respective recesses 33, so that the respective recesses 33 are accessible via the respective through-openings 6.

FIG. 3B shows a schematic sectional view of the pressing tool 10 shown in FIG. 3A after finishing of the hybrid component 1 in an opening movement after leaving a closed position.

During the closing of the pressing tool 10, the ribs 3 are formed from material of the polymer melt P by pressing the material of the polymer melt P through the respective through-openings 6 into the respective recesses 23.

FIGS. 4A and 4B show a pressing tool 10 according to a fourth embodiment of the present invention in a schematic sectional view, based on which the production process of a further hybrid component 1 is explained. FIG. 4A shows a schematic sectional view of a pressing tool 10 for producing a hybrid component 1 in a first position of a hold-down device according to a fourth embodiment of the present invention. The pressing tool 10 comprises a hold-down device 40 attached to the lower tool part 20, which can be moved in the movement direction R between a first position and a second position.

In the first position of the hold-down device 40, the at least one protection element 7 is clamped between the hold-down device 40 and the upper tool part 30.

The first position of the hold-down device 40 is reached during the closing movement of the pressing tool 10 before the closing position of the pressing tool 10. As a result, the at least one protection element 7 is clamped between the hold-down device 40 and the upper tool part 30 before the at least one protection element 7 is deformed.

The pressing tool 10 is designed to hold the at least one protection element 7 clamped between the hold-down device 40 in the first position and the upper tool part 30 during the closing movement and to deform the at least one protection element 7 by way of application of force by means of the at least one polymer melt P during the closing movement of the pressing tool 10.

The hold-down device 40 comprises a spring bearing 41, by means of which the clamping force can be adjusted during the deformation of the protection element 7.

FIG. 4B shows a schematic sectional view of a pressing tool 10 for producing a hybrid component 1 in a second position of the hold-down device 40 according to the fourth embodiment of the present invention.

In the second position, the at least one protection element 7 is loosely arranged between the hold-down device 40 and the upper tool part 30 with respect to the movement direction R.

The second position of the hold-down device 40 is reached during the opening movement of the pressing tool 10 before the open position of the pressing tool 10. As a result, the hybrid component 1 can be ejected more quickly after finishing.

### LIST OF REFERENCE SIGNS

1 Hybrid component
2 Plastics layer (of the hybrid component)
3 Ribs (of the plastics layer)
4 (First) protection element (of the hybrid component)
5 Contact surface (of the first protection element)
6 Through-opening (of the protection element)
7 (Second) protection element (of the hybrid component)
8 Contact surface (of the second protection element)
10 Pressing tool
20 Lower tool part (of the pressing tool)
21 Holding device (of the lower tool part)
22 Reshaping device (of the lower tool part)
23 Recess (of the lower tool part)
24 Ejector device/ejector pins (of the lower tool part)
30 Upper tool part (of the pressing tool)
32 Reshaping device (of the upper tool part)
33 Recess (of the upper tool part)
34 Holding device (of the upper tool part)
40 Hold-down device/holding device
41 Spring bearing (of the hold-down device)
P Polymer melt
R Movement direction (of the upper tool part with respect to the lower tool part)

1. A method for producing a hybrid component (which comprises at least one plastics layer and at least one protection element which is connected to the plastics layer, wherein the method comprises the following method steps:
providing a pressing tool which comprises a lower tool part and an upper tool part wherein the upper tool part and the lower tool part are movable relative to one another along a movement direction between an open position and a closed position of the pressing tool;
placing at least one protection element and at least one polymer melt into the pressing tool in the open position, in such a way that the polymer melt and the protection element are arranged one above the other along the movement direction; and
closing the pressing tool, with the result that the upper tool part comes into contact at least indirectly with the at least one polymer melt or with the at least one protection element and the polymer melt is reshaped by way of application of pressure by means of the upper tool part and/or by means of the lower tool part and the at least one polymer melt is connected to the at least one protection element with the formation of the plastics layer.

2. The method according to claim 1, the method further comprising the following method step:
deforming the at least one protection element by exerting force by means of the at least one polymer melt.

3. The method according to claim 1, the method further comprising the following method steps:
placing the at least one protection element in the pressing tool in the open position in such a way that the at least one protection element rests at least indirectly on the lower tool part; and
placing the at least one polymer melt onto the at least one protection element.

4. The method according to claim 3, the method further comprising the following method steps:
placing a second protection element in the pressing tool in the open position in such a way that the polymer melt is arranged between a first protection element which rests at least indirectly on the lower tool part, and the second protection element and
closing the pressing tool so that the upper tool part comes into contact at least indirectly with the second protection element and the polymer melt is connected to the first protection element and the second protection element by way of application of pressure by means of the upper tool part and/or by means of the lower tool part.

5. The method according to claim 1,
wherein a plurality of recesses are formed in the lower tool part and/or in the upper tool part, the method further comprising the following method step:
forming a plurality of ribs from material of the polymer melt during the closing of the pressing tool, by pressing the material of the polymer melt into the recesses.

6. The method according to claim 5, the method further comprising the following method steps:
placing at least one protection element which comprises a plurality of through-openings and the at least one polymer melt, into the pressing tool; in the open position in such a way that the polymer melt and the protection element are arranged one above the other along the movement direction, and that the respective through-openings are in each case oriented in alignment with the respective recesses, so that the respective recesses are accessible via the respective through-openings; and
forming a plurality of ribs from material of the polymer melt during the closing of the pressing tool, by pressing the material of the polymer melt through the respective through-openings into the respective recesses.

7. The method according to claim 1, the method further comprising the following method step:
heating the at least one protection element before bringing it into contact with the at least one polymer melt and/or before closing the pressing tool.

8. The method according to claim 1, the method further comprising the following method step:
microstructuring a contact surface of the at least one protection element, which is connected to the at least one polymer melt with the formation of the plastics layer.

9. The method according to claim 1, the method further comprising the following method step:
applying an adhesion promoter to a contact surface of the at least one protection element, which is connected to the at least one polymer melt with the formation of the plastics layer.

10. A pressing tool for producing a hybrid component which comprises at least one plastics layer and at least one protection element which is connected to the plastics layer, wherein the pressing tool comprises:
a lower tool part:
an upper tool part,
wherein the upper tool part and the lower tool part are movable relative to one another along a movement direction between an open position and a closed position of the pressing tool; and
a holding device for holding the at least one protection element in the pressing tool,
wherein the pressing tool (10) is configured so that when the pressing tool is transferred into its closed position, a polymer melt introduced into the pressing tool and a protection element introduced into the pressing tool are pressed onto one another and connected to one another, wherein the polymer melt introduced into the pressing tool is deformed with the formation of the plastics layer.

11. The pressing tool according to claim 10, further comprising:
a plurality of recesses are formed in the lower tool part and/or in the upper tool part,
wherein the pressing tool is configured in such a way that when the pressing tool is transferred into its closed position, the polymer melt is pressed at least partially into the plurality of recesses, so that the plastics layer comprises a plurality of ribs monolithically connected to it.

12. The pressing tool according to claim 10, further comprising:
an ejection device for ejecting the hybrid component,
wherein the ejection device is configured to separate the hybrid component from the lower tool part and/or the upper tool part after finishing of the hybrid component by way of application of force to the hybrid component.

13. The pressing tool according to claim 10,
the upper tool part and/or the lower tool part comprises a reshaping device for reshaping the at least one protection element; and
wherein the pressing tool is configured to deform the at least one protection element by way of application of force by means of the at least one polymer melt in the direction of the reshaping device during the closing movement of the pressing tool.

14. The pressing tool according to claim 10, further comprising:
a hold-down device attached to the lower tool part, which can be moved in the movement direction between a first position and a second position;
wherein in the first position, the at least one protection element can be clamped between the hold-down device and the upper tool part,
wherein in the second position, the at least one protection element is freely movable between the hold-down device and the upper tool part with respect to the movement direction,
wherein the pressing tool is configured to hold the at least one protection element clamped between the hold-down device in the first position and the upper tool part during the closing movement, and
wherein the pressing tool is designed to deform the at least one protection element by way of application of force by means of the at least one polymer melt during the closing movement of the pressing tool.

15. The pressing tool according to claim 10, wherein
the upper tool part comprises a holding device for holding the at least one protection element in the pressing tool, and
the holding device is configured as a magnetic holding device or as a holding device generating a negative pressure.
